(19) United States
(12) Patent Application Publication
(10) Pub. No.: US 2024/0345559 A1
(43) Pub. Date: Oct. 17, 2024

(54) METHOD FOR OPERATING A SHAPING MACHINE

(71) Applicant: ENGEL AUSTRIA GmbH, Schwertberg (AT)

(72) Inventors: Philipp Willnauer, Mitterkirchen (AT); Georg Pillwein, Linz (AT)

(21) Appl. No.: 18/591,809

(22) Filed: Feb. 29, 2024

(30) Foreign Application Priority Data
Mar. 2, 2023 (AT) A 50154/2023

(51) Int. Cl. G05B 19/042; B29C 37/00

(52) U.S. Cl. CPC G05B 19/042; B29C 2037/903; G05B 2219/2624

(57) ABSTRACT

A method for operating a molding machine includes providing dependencies between, in particular unsorted and/or partially circularly interdependent, actions for performing at least one task. The at least one task is or comprises an operation, a startup or shutdown, a maintenance and/or an optimization of a molding process and/or a molding machine and/or a mold. The method further includes sorting the actions based on the dependencies between the actions.

The present invention relates to a method for operating a molding machine according to the features of the preamble of claim 1.

The invention also relates to a computer program product, a control unit and a molding machine.

By molding machines can be meant die-casting machines, injection-molding machines, transfer-molding machines, molding presses and the like.

The operation of a molding machine generally comprises a plurality of subprocesses, working steps or actions, influencing factors and other aspects to be taken into account, with the result that the proper operation of a molding machine represents a complex task for an operator.

The operator often relies on many years of experience and sometimes even on intuition, wherein not every operator knows the correct sequence of working steps and/or the ranges of various target values. Problems connected with this are that inconsistent operating procedures can prevail in-house, potential errors can occur during operation of the molding machine, damage to the tool or to the molding machine can occur or the full potential of the molding machine remains underutilized.

Methods for assisting the operator are known in principle. For example, EP 2953778 A1 and EP 2358514 A1 provide methods which assist the operator in obtaining a process-capable initial or basic setting for a molding machine, in order to produce a particular molded part. EP 3546182 A1 also shows a display device on which an operator can interactively arrange working steps for a molding process and wherein a control unit indicates in a supporting manner whether the selected steps within the sequence are possible or impossible. However, a disadvantage of the solution of EP 3546182 A1 is that the operator largely has to rely on their own knowledge in order to be able to create a useful sequence of working steps. The less knowledge an operator has, the more the interactive creation of the sequence of working steps becomes a trial-and-error endeavor, as the control unit only ever responds to a selection by the operator instead of offering a suggestion.

In the methods of the named documents and also in many other methods, it is unfavorable that they are limited in each case only to particular subprocesses or -steps. Moreover, only machine-side dependencies between working steps and no other possible relevant, e.g. physical or process-typical, aspects are for the most part taken into account.

The object of the present invention is therefore to provide a method which is improved in relation to the state of the art, assists an operator comprehensively, both acts and reacts and in the process takes all practically possible influencing factors with respect to the operation of a molding machine into account.

This object is achieved by the features of claim 1, namely with a method for operating a molding machine,
wherein dependencies between, in particular unsorted and/or partially circularly interdependent, actions for performing at least one task are provided, wherein the at least one task is or comprises an operation, a startup or shutdown, a maintenance and/or an optimization of a molding process and/or a molding machine and/or a mold and
wherein the actions are sorted based on, i.e. taking into account, the dependencies between the actions.

A major advantage of the invention is that, starting from at least one predetermined or defined task which relates to the operation of a molding machine, the actions relevant and/or necessary for this are automatically sorted.

The sorted sequence of actions can be provided to an operator and/or automatically processed and/or used by the molding machine.

The operator therefore does not require any knowledge of the dependencies that are crucial for sorting the actions and can simply depend on the fact that the sorted sequence of actions provided by the method can be reasonably and practically implemented.

That is to say the operator merely has to define a task or an aim, whereupon a sorted sequence of actions which are necessary for performing the defined task can be provided automatically by means of the method.

Of course, the operator can, if necessary, also influence the actions and/or change or adapt the at least one task.

In the case of at least one change in the task, actions and/or dependencies, the method can also be carried out again, in particular automatically and/or at least partially, in order to take the at least one change into account.

A further major advantage of the invention is that the method can assist an operator in performing any task which is conceivably possible with respect to the operation of a molding machine and is not limited to particular subprocesses or -steps.

The at least one task can relate to and/or comprise an operation, a startup or shutdown, a maintenance and/or an optimization of a molding process and/or a molding machine and/or a mold and/or a peripheral device.

Moreover, all dependencies between the actions that are conceivable with respect to the operation of a molding machine can advantageously be taken into account. That is to say the dependencies are not only limited to machine-side, tool-side, process-specific and/or peripheral device-specific dependencies.

The dependencies are provided and/or obtained and/or acquired in the first step of the method, wherein they can be in particular random, unsorted and/or at least partially circularly interdependent.

The dependencies between the actions can be input by an operator and/or read out of a database and/or at least partially determined substantially automatically by means of a further computer program product, assistant or the like.

For example, the dependencies between actions can be obtained on the basis of the visualization device provided in EP 3804951 B1 (visualization device for a production system, which contains at least one cyclically operating molding machine, for visualizing a process state of the production system) and/or by means of the method provided in AT 508492018 A (method for determining a physical relationship between at least one setting parameter of a production cycle of a cyclically operating shaping machine and at least one selected process or quality parameter of the production cycle of the shaping machine), in particular wherein tool-specific dependencies are determined in the system, and the sorted sequences of actions that are optimum for these dependencies can be determined.

In a particularly preferred variant of the method according to the invention, the dependencies, in particular molding machine-specific dependencies, between the actions are provided automatically on the basis of a, for example manufacturer-side, predetermined machine configuration of a particular molding machine.

A further major advantage of the method is that even circularly or cyclically interdependent actions—regarded as problematic during sorting—can be sorted.

Actions are, for example,
an adaptation of a melt cushion monitoring,
a setting of a clamping force,
a setting and/or adaptation of at least one setting and/or target value, such as e.g. relating to the injection profile, the holding pressure level, running-in cycles, cyclic adaptations of the switchover point and/or one-off adaptations of the holding pressure time for defined cycles, by the operator, for example by input and/or at the press of a button, the molding machine and/or by a further computer program product, an assistance device or the like,
a manual activity by the operator, in particular for a material, machine, peripheral device and/or tool change, such as e.g. the coupling of an ejector, the connection of a hose,
an automatic recognition of a deviation of a parameter, e.g. of an actual value from a target value, and/or of an alteration of the molding machine, e.g. relating to a material change, tool wear, draft, by a further computer program product, an assistance device or the like, and/or
an input by an operator, in particular after the manually effected action, such as e.g. after a material change has been carried out or after maintenance of a tool.

The method therefore offers a comprehensive assistance during the operation of a molding machine, wherein the operator is relieved as much as possible.

The sorted actions and/or the sorted sequence of actions are determined automatically by means of the method and should only need to be adapted by the operator in exceptional cases.

This method is therefore based on the principle of not requiring expert knowledge in order to be able to perform a defined task, i.e. to automate the operation of a molding machine as far as possible.

Through the use of the method, all necessary actions for performing the at least one predetermined task are taken into account and are usefully sorted, in particular in an optimized manner. That is to say no necessary actions are left out and they also cannot be forgotten by the operator.

The sorted sequence of actions can in principle be regarded as a suggestion or as a recommendation, to which the operator can bring their knowledge.

If the operator is not satisfied e.g. with the sorted sequence of actions, the dependencies and/or the sensitivity of the notification, the sequence of actions, the dependencies and/or the notifications can be adapted.

If the operator becomes aware e.g. of new dependencies and/or requires an additional step or an additional action to perform a task, further actions and/or dependencies can be easily added, whereupon a new sorted sequence of actions, in particular in the sense of an optimum order, is determined in particular with the aid of an algorithm.

In a particularly preferred variant, the molding machine, preferably and all associated peripheral devices, sets all actions automatically, i.e. independently without the help of an operator.

A further advantage of the invention is that the sorted sequence of actions can also be easily transferred to further machines or systems of a machine park. With a uniform procedure for performing defined tasks in a group of companies or plant, errors can be prevented, time can be saved and costs can thus be reduced.

Further advantageous embodiments of the invention are defined in the dependent claims.

The at least one task to be performed can be or comprise, for example, a saving of energy, a reduction of a cycle time, an optimization of a process setting, an initial sampling, a setting-up, a heating-up, a preparation, a starting of production, a monitoring of production, a stopping of production, a starting-up and/or a stopping of a molding process and/or a molding machine and/or a mold and/or a peripheral device.

By peripheral device is meant at least one peripheral device which cooperates with a molding machine during the production of molded parts and can for example relate to the drying, conveying, metering, temperature control of a molding process and/or the recycling of materials and/or the handling of molded parts.

Peripheral devices can be robots, conveyor belts, dryers, metering devices and/or temperature control devices etc.

It is particularly preferably provided that, before the sorting of the actions, a presorting or ordering of the actions to give a presorted order or sequence of actions is effected, with the result that the method can be taken to mean a multi-level sorting algorithm.

The presorting serves in particular to ensure that the result or the sorted sequence of actions is independent of the original order or the, possibly randomly, unsorted sequence of actions.

It can be provided that the presorting of the actions is effected according to an, in particular strict, total order, for example in alphabetical order.

It is preferably provided that circular or cyclic dependencies of the dependencies between the actions are identified and/or referenced, i.e. in particular assigned to the associated circularly interdependent actions.

Actions can be set or carried out by an operator, a molding machine, an assistance device and/or a program.

The dependencies between the actions can be induced physically and/or logically and/or process-specifically and/or molding machine-specifically and/or tool-specifically and/or peripheral device-specifically.

A physical dependency is for example that a longer cooling time follows a higher temperature.

A logical dependency is for example that an ejector of a molding machine can only be coupled if a tool is clamped.

Process-specific dependencies relate for example to different process types depending on the type of material to be plasticized, e.g. thermoplastic or elastomer, and/or properties of the process, e.g. high-speed designs.

Tool-specific dependencies relate for example to specific properties, the type or design of the tool, such as e.g. of the hot runners, cold runners, multiple cavities, sliders, etc.

Molding machine-specific dependencies relate in particular to the type, design, properties and/or parameters of the molding machine.

All dependencies, actions, sequences of actions and/or notifications can also be classified and/or stored, e.g. in peripheral device-, tool-, machine- and/or process-specific elements, and/or can be transferred as a plant or group configuration to further systems and/or molding processes.

The operator can make their configured and/or stored dependencies, sequences of actions, actual values, and/or threshold values and/or all reciprocal relationships and/or effects connected therewith, such as e.g. the alteration of an actual value due to a set action, available to other users for their machine park and/or to the manufacturer for a plant-side preconfiguration.

It is particularly preferably provided that the circularly interdependent actions connected by means of circular dependencies are combined, in particular and referenced, to form at least one aggregate action.

It can be provided that the circular dependencies between the circularly interdependent actions are combined, in particular and referenced, into at least one aggregate dependency.

It is particularly preferably provided that a reduced set of actions, which contains the actions minus the circularly interdependent actions contained in the at least one aggregate action as well as the at least one aggregate action, is sorted by means of, in particular topological, sorting.

In other words, the reduced set of actions comprises the at least one aggregate action and actions minus the circularly interdependent actions contained in the at least one aggregate action.

The, in particular topological, sorting of the reduced set of actions is effected in particular to solve the problem of circular or cyclic dependencies between the actions. A topological sorting is namely impossible in principle if circular dependencies exist.

A further disadvantage of a topological sorting is that the sequence of actions resulting from the topological sorting is not always clear. It is therefore particularly preferably provided that (as already mentioned above), before the sorting of the actions, a presorting of the actions is effected, with the result that the sorted sequence of actions is independent of the original unsorted sequence of the actions, i.e. ultimately always the same.

The procedure of combining circularly interdependent actions to form at least one aggregate action and/or sorting the reduced set of actions can be regarded as a modified and/or enhanced topological sorting of the actions.

It is particularly preferably provided that the at least one aggregate action of the sorted reduced set of actions is replaced with the respective circularly interdependent actions, which circularly interdependent actions were combined beforehand to form the respective at least one aggregate action.

The sequence or order of the actions without the circularly interdependent actions, which were combined to form aggregate actions, remains the same. The sequence of the circularly interdependent actions, which were combined to form aggregate actions, within the sorted reduced set of actions can first of all be freely chosen.

The sequence of circularly interdependent actions, which were combined to form aggregate actions, can, during the operation of a molding machine, follow each other directly and/or separated by a particular, in particular small, number of actions and/or go together thematically from the point of view of an expert operator and/or correspond to each other physically, logically, process-specifically, peripheral device-specifically, machine-specifically and/or tool-specifically.

By peripheral device-specific actions is meant actions which relate to peripheral devices of a molding machine.

Peripheral device-specific actions can relate for example to a drying, conveying, metering and/or temperature control in the course of a molding process and/or the recycling of a material and/or the handling of molded parts.

It is preferably provided that the circularly interdependent actions forming the respective at least one aggregate action are set or executed or carried out simultaneously and/or iteratively, in particular by an operator.

It can be provided that those presorted and/or sorted actions which are independent of other actions are additionally sorted at least once, for example by means of a total order.

In a particularly preferred variant of the method, the following steps are carried out:
providing an, in particular random, unsorted order or sequence of working steps or actions for performing at least one defined task; and
presorting the unsorted actions according to a total order, e.g. as alphabetical sorting; and
identifying circular dependencies between the actions and/or the circularly interdependent actions associated with the circular dependencies; and
combining the identified circularly interdependent actions to form at least one aggregate action; and
carrying out a topological sorting of a reduced set of actions, wherein the reduced set of actions contains the actions minus the circularly interdependent actions contained in the at least one aggregate action as well as the at least one aggregate action; and
replacing the at least one aggregate action with the respective circularly interdependent actions, which were combined beforehand to form the respective aggregate action.

Those actions of the created sorted sequence of actions which have no dependencies can optionally be subjected to a further sorting.

It is particularly preferably provided that the actions, the dependencies between the actions and/or the at least one task can be determined, edited and/or influenced in particular by an operator.

It is particularly preferably provided that the sorted actions or the sorted sequence of actions for performing the at least one predetermined task are or is output, in particular in graphic, tabular and/or textual form.

It is preferably provided that actions for performing the at least one task that have already been executed, are currently being processed, still to be performed, unavailable conceivable and/or deactivated are obtained, acquired, output and/or stored.

For every action or for every working step, status information is ascertained, presented and/or wherein the status stored, information can include the following information:
action is to be carried out
action is currently being carried out
action has been completed
action is not available
action is deactivated

In the case of a change in the at least one task, action and/or dependency, a new sorting of the actions can be effected, with the result that the status information can change.

Unavailable conceivable actions can be taken to mean actions which are theoretically and/or in principle possible for the operation of a molding machine but are not available on a particular molding machine.

Deactivated actions can be for example actions which are in principle possible and available on a particular molding machine but were deactivated by an operator.

The output of the actions, in particular for assisting the operator, is preferably effected in graphic and/or tabular and/or textual form.

It is particularly preferably provided that an operator is informed,
in particular as a reminder or warning, to set and/or to repeat an, in particular open, action and/or
that, in particular when a threshold value is exceeded and/or fallen below, an action or actions has or have effects on an action or actions and/or a process in the course of the operation of the molding machine and/or
what effect or effects, in particular exceeding and/or falling below a threshold value, the setting of an action or actions has or have on an action or actions and/or a process of operating the molding machine.

With the aid of information and/or notifications the operator can be made aware of open actions and thus be guided through the task to be performed.

Protection is also sought for a computer program product, comprising commands which, when the program is executed by a computer, prompt it to perform the following steps:
obtaining and/or acquiring dependencies between, in particular unsorted and/or partially circularly interdependent, actions for performing at least one, in particular predetermined, task, wherein the at least one task is or comprises an operation, a startup or shutdown, a maintenance and/or an optimization of a molding process and/or a molding machine and/or a mold; and
sorting the actions based on, i.e. taking into account, the dependencies between the actions.

Protection is furthermore sought for a system with a memory remote from a control unit of the molding machine, in which memory the computer program product according to the invention is stored.

It is particularly preferably provided that the system is set up to execute the computer program using at least one processor.

The system can be taken to mean a cloud system or be part of a cloud system, which cloud system can comprise servers, data storage devices, programs etc.

Protection is also sought for a control unit for a molding machine wherein
the control unit is set up to communicate with the system and/or
the control unit is set up to execute the computer program product according to the invention and/or
the control unit has a memory, in which the computer program product according to the invention is stored, and the control unit is set up to execute the computer program product and/or
the control unit is set up to carry out the method according to the invention or a variant thereof.

A computer program product according to the invention can also be employed by being used in already known embodiments of control units for molding machines and/or systems, in particular cloud systems, of the state of the art and installed subsequently.

Protection is furthermore sought for a molding machine with a control unit according to the invention.

It is preferably provided that the molding machine has a display unit for displaying information about an operation of the molding machine, in particular for assisting an operator.

There are a wide variety of applications for the method according to the invention and/or the system and/or the computer program product and/or the molding machine, and/or variants thereof. Some application examples may be specified below:

Application example 1: the operator would like to execute at least one particular task, such as e.g. the optimization of production, the saving of energy and/or the reduction of a cycle time, and for this purpose obtains as short as possible an optimum sorted sequence of actions, in particular with an item of information about the status and/or the progress of the individual actions within the sorted sequence of actions.

Application example 2: the operator changes a process variable due to particular influences and is made aware of significant effects in the process and/or on subsequent actions of the sorted sequence of actions for remedying and/or compensating for the effects, such as e.g. that a higher cylinder temperature results in a longer cooling time.

Application example 3: if the operator increases a holding pressure level due to sink marks on the component part, they are reminded to carry out further necessary actions, such as e.g. an adaptation of the melt cushion monitoring, an increase of the clamping force to avoid feathering, a re-referencing and/or an activation of assistance devices (e.g. iQ weight control) to achieve a stable production. If it is necessary to adapt setting values, a suggestion for the new setting value is in particular also output.

Application example 4: the operator receives, for automatic actions and/or those to be carried out manually for the tasks “initial sampling” and “optimize production”, the optimum sorted sequence of actions for performing these tasks.

Application example 5: with the aim of gentler plasticizing, reducing the energy consumption and/or reducing wear, the operator changes and/or optimizes a metering rate in order to take full advantage of a cooling time. This alters the viscosity of the plasticized material, which has an effect on the next actions. The operator is made aware of these effects and/or the following actions, wherein an output of actions to be set takes place, such as e.g. “adapting the metering time monitoring”, “adapting the injection rate” and/or other injection parameters (switchover point, holding pressure level, holding pressure time, etc.) and/or setting new reference states of assistance devices (e.g. iQ weight control and/or iQ process observer).

Application example 6: a molding machine is preset on the manufacturer side with an advantageous machine configuration, wherein, through the advantageous machine configuration, dependencies between the actions, in particular molding machine-specific dependencies, and/or a recommended sequence of actions for performing at least one task, such as e.g. “optimize molded part quality”, are provided. The molding machine automatically recognizes during its operation environmental parameters, such as e.g. draft or humidity, and effects, dependencies and/or actions connected therewith, and prompts at least one sorting or re-sorting of the actions. This allows a, preferably automatic, adaptation and/or storage of the machine configuration to specific circumstances for optimally performing the task, in particular corresponding to the individual requirements of a mold, a molded part to be produced, a material used etc.

Further advantages and details of advantageous variants and application examples of the invention are revealed by the figures and the associated description of the figures. There are shown in:

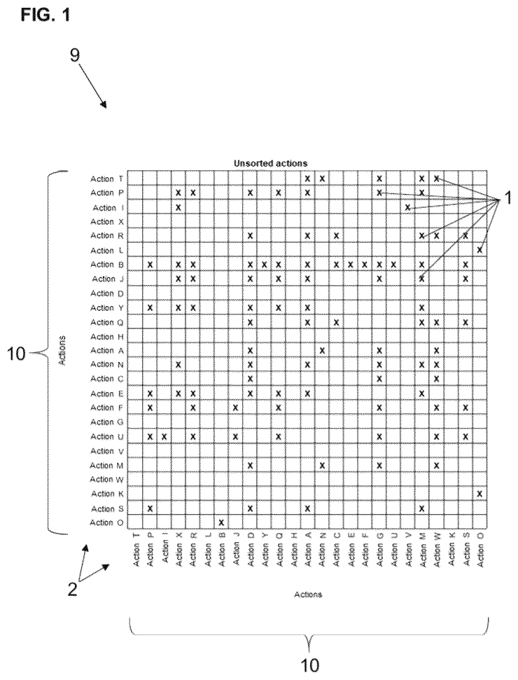

FIGS. 1-6 a variant of the method according to the invention,

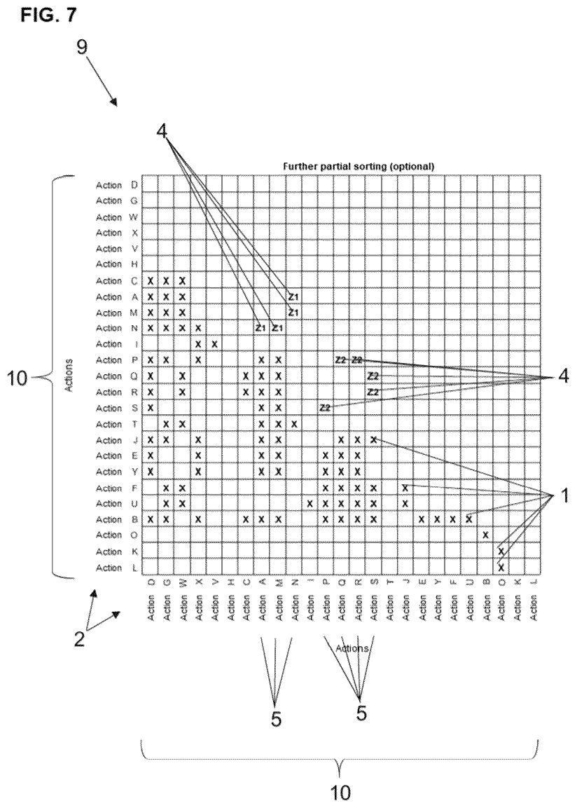

FIG. 7 an optional advantageous method step,

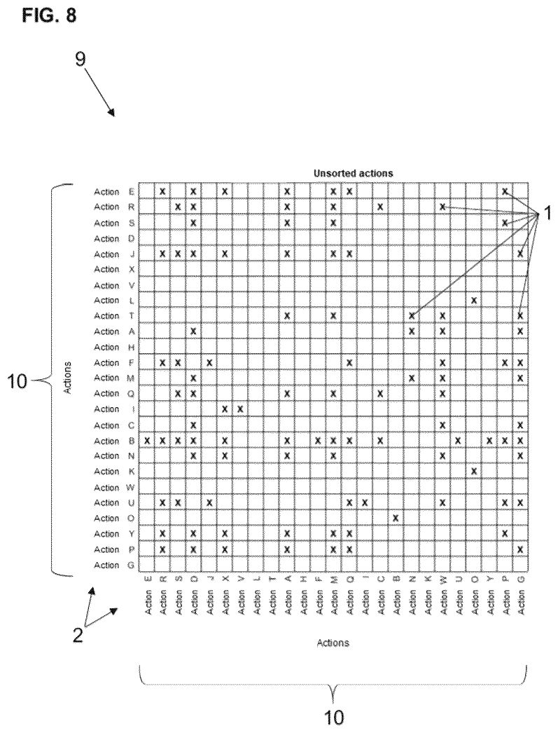

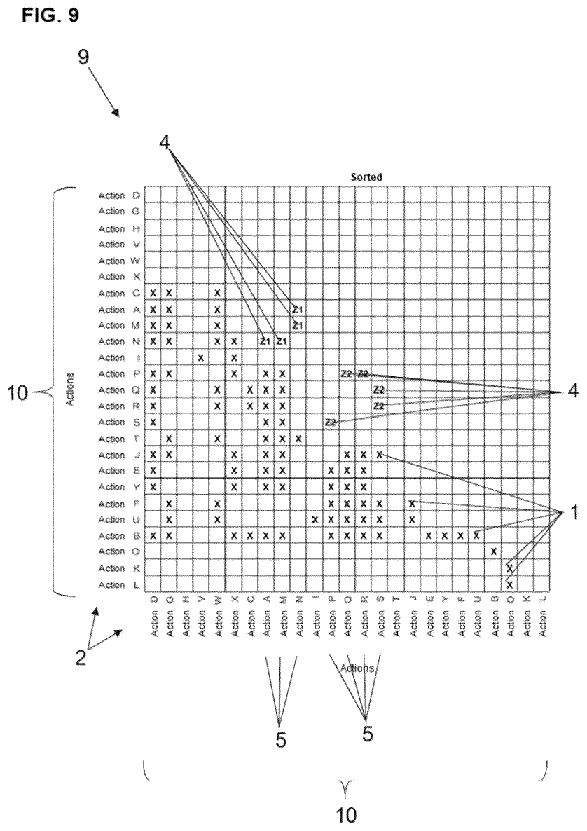

FIGS. 8-9 an optional advantageous method step,

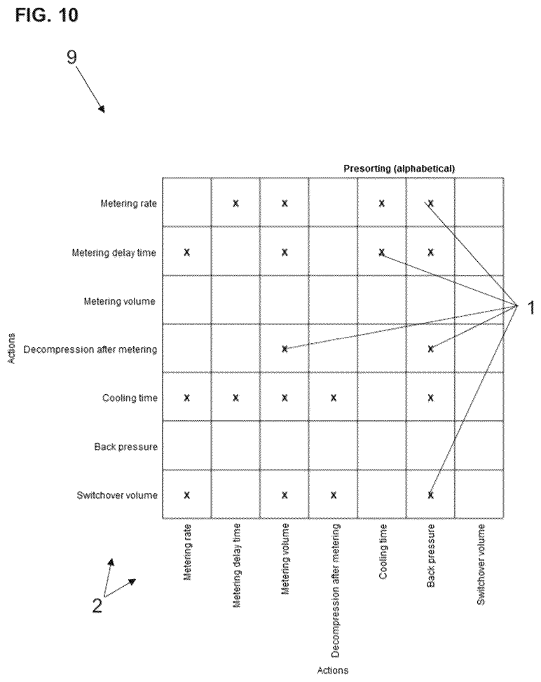

FIGS. 10-12 substeps of a specific example of a variant of the method,

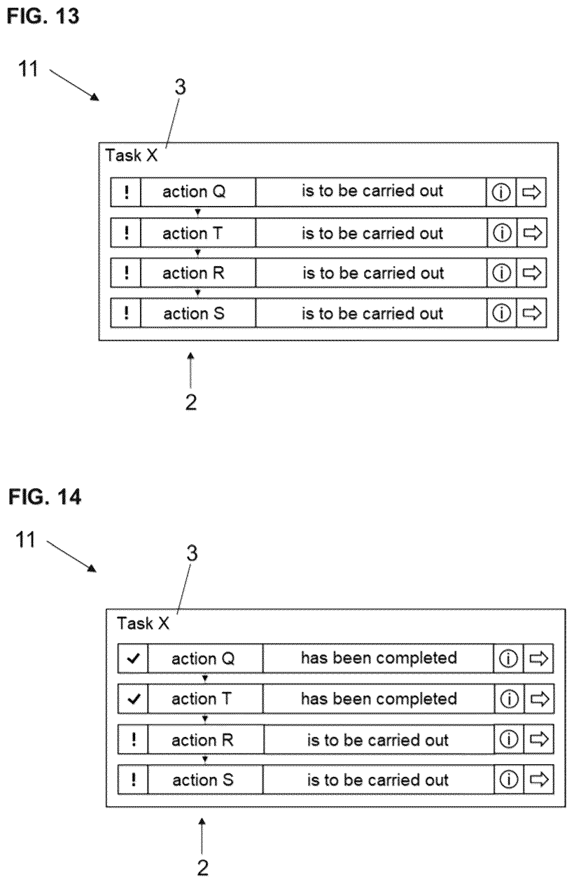

FIGS. 13-16 a first output screen for assisting an operator and

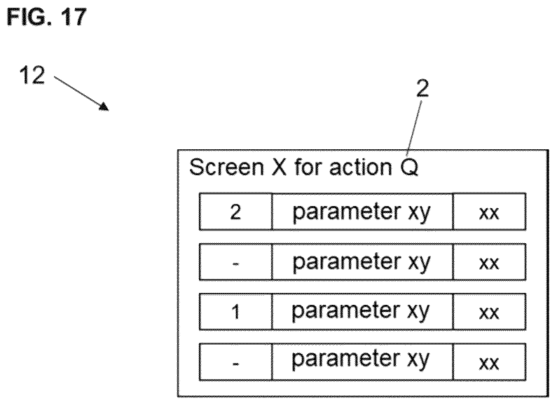

FIG. 17 a second output screen for assisting an operator.

FIGS. 1-6 show an advantageous variant of a method according to the invention, wherein each figure shows a matrix 9 with actions 2 and dependencies 1, wherein the sequence of figures substantially corresponds to a sequence of method steps. Dependencies 1 that exist between the actions 2 are marked by an “X” in the respective matrix 9, wherein these dependencies 1 can be circular dependencies 4 or linear or unique dependencies 1 with unique predecessors and successors. Circular dependencies 4 between circularly interdependent actions 5 are marked by a “Z” or by “Z1” and “Z2”.

The variant of the method according to the invention shown in FIGS. 1-6 comprises the following steps corresponding to the figures:

FIG. 1: providing an, in particular random, unsorted sequence of actions 2 for performing at least one defined task 3; and

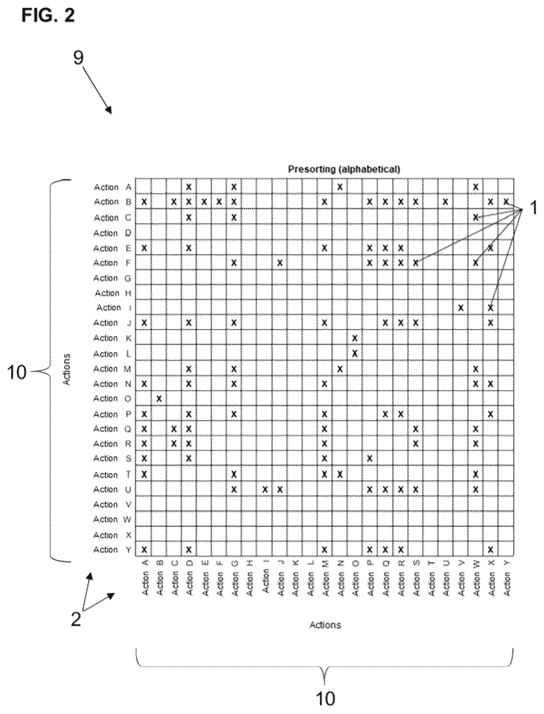

FIG. 2: presorting the unsorted actions 2 according to a total order, e.g. in alphabetical order; and

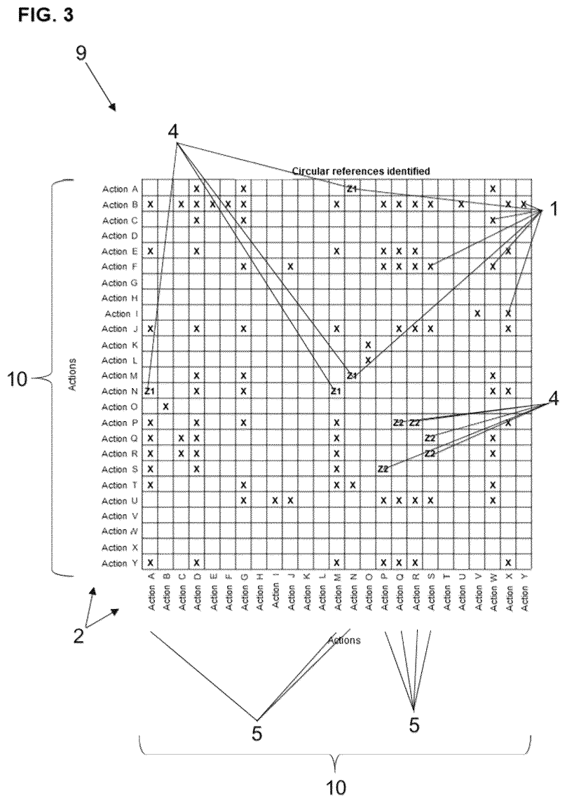

FIG. 3: identifying circular dependencies 4 (“Z1”, “Z2”) between the actions 2 and/or the circularly interdependent actions 5 associated with the circular dependencies 4; and

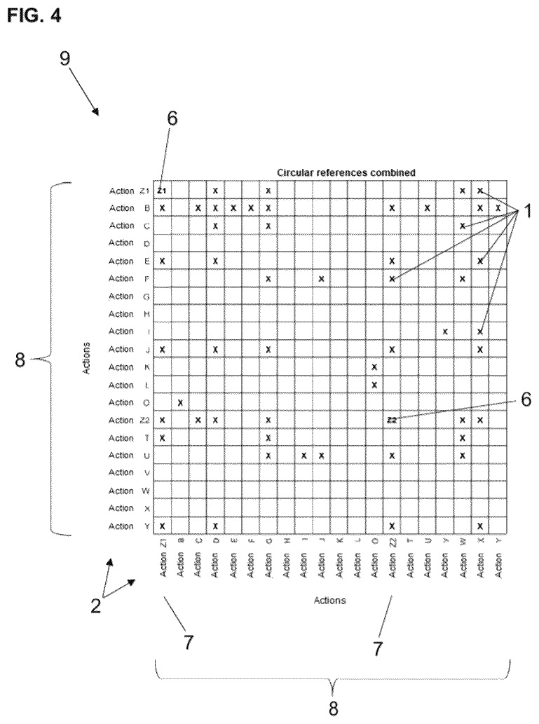

FIG. 4: combining the identified circularly interdependent actions 5 to form at least one aggregate action 7 (“Z1”, “Z2”); and

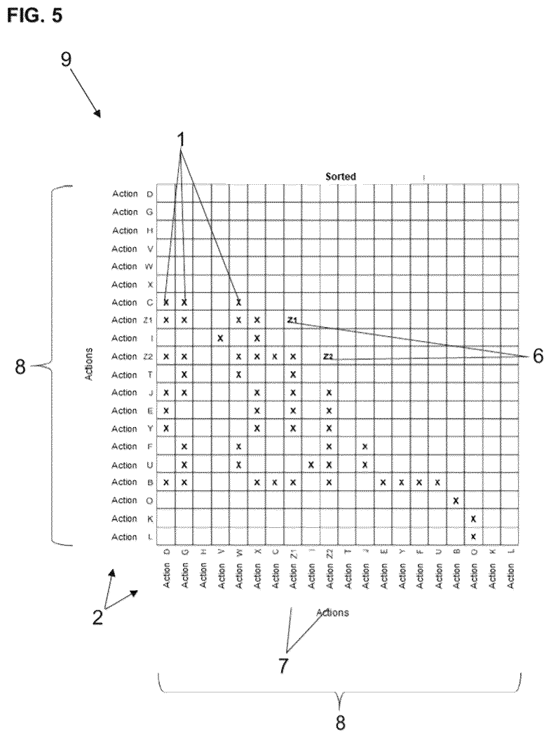

FIG. 5: carrying out an, in particular topological, sorting of a reduced set of actions 8, wherein the reduced set of actions 8 contains the actions 2 minus the circularly interdependent actions 5 contained in the at least one aggregate action 7 (“action Z1”, “action Z2”) as well as the at least one aggregate action 7; and

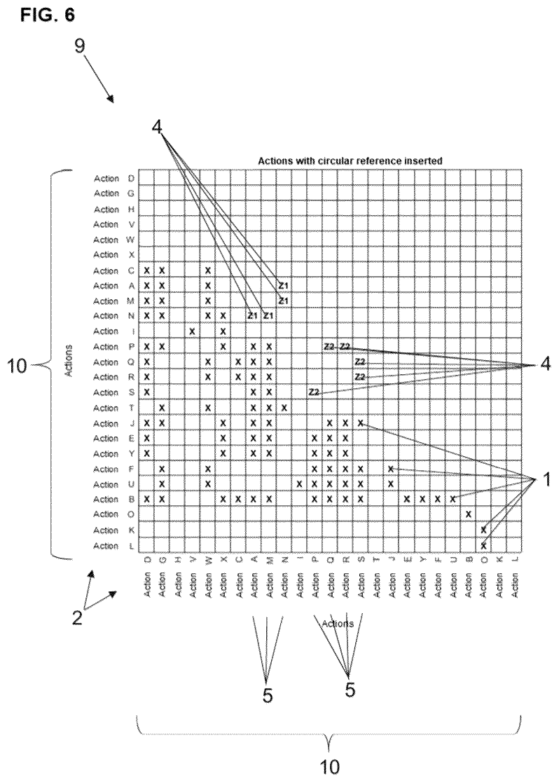

FIG. 6: replacing the at least one aggregate action 7 (“action Z1”, “action Z2”) with the respective circularly interdependent actions 5, which were combined beforehand to form the respective aggregate action 7.

FIG. 1 shows the unsorted matrix 9 of the actions 2 A to Y, i.e. of the unsorted total set of actions 10, wherein some actions 2 have dependencies 1 X on each other. For example, action 2 R is dependent on the actions 2 D, A, C, M, W and S.

FIG. 2 shows the matrix 9 from FIG. 1 after presorting has been effected by means of alphabetical sorting. The dependencies 1 have not changed as a result. Action 2 R is still dependent on the actions A, C, D, M, S and W.

In FIG. 3, the circular dependencies 4 have been identified and referenced with their associated circularly interdependent actions 5. For example, action 2 N is dependent on action 2 A and action 2 M; action 2 M is dependent on action 2 N; and action 2 A is likewise dependent on action 2 N. The actions 2 {A, M, N} form the circular dependencies 4 or the circular reference Z1. Analogously, the actions 2 {P, Q, R, S} form the circular dependencies 4 or the circular reference Z2.

In FIG. 4, the actions 2 or circularly interdependent actions 5 {A, M, N} and {P, Q, R, S} have been combined to form the aggregate actions 7 Z1 and Z2, respectively, as a result of which the total set of actions 10 has become a reduced set of actions 8.

During the combination to form aggregate actions 7, the dependencies 1 relative to the remaining actions 2 are preferably linked with a logical “or”, which results in the fact that, when at least one of the actions 2 of circularly interdependent actions 5 or of a circular reference has a particular dependency 1, then all actions 2 of the circularly interdependent actions 5 or of the circular reference in question have this dependency 1.

FIG. 5 shows a sorted reduced set of actions 8 after sorting has been effected, in particular by means of an algorithm for topological sorting. The successful sorting is recognizable by the fact that no more dependencies 1 occur above the diagonal of the matrix 9.

In FIG. 6, the aggregate actions 7 Z1 and Z2 have again been replaced with the circularly interdependent actions 5 {A, M, N} and {P, Q, R, S}, respectively, wherein the reduced set of actions 8 has become a sorted total set of actions 10. As the circularly interdependent actions 5 or the circular references cannot be sorted topologically, they come t partially above the diagonal of the matrix 9.

Circularly interdependent actions 5 are preferably considered collectively and executed in parallel and/or iteratively. That is to say, for example, that the operator and/or the molding machine fixes at least one action 5 of the circularly interdependent actions 5, preferably based on collected data, simultaneously and/or successively, wherein it may be the case that a particular fixing of an action 2 has an effect on at least one further action 2, which can result in an iterative execution of the actions 2.

An optional particularly preferred method step is shown in FIG. 7, which is preferably carried out after sorting has been effected (FIG. 6) and wherein parts of the matrix 9 which have no dependencies 2 between the actions 2 are subjected to a further sorting. In FIG. 7, this partial sorting has been effected for the first six actions 2 {D, G, W, X, V, H}, in particular according to the number of actions 2 {C, A, M, N, . . . , U, B} that are dependent on these six actions 2.

FIG. 8 shows a random initial sorting, deviating from FIG. 1, of the actions 2 or a further random unsorted total set of actions 10, wherein, however, the same dependencies 1 between the actions 2 exist. That is to say that action 2 R again depends on the actions 2 S, D, A, M, C and W.

Carrying out the method steps represented by FIGS. 1-6 gives the result of a sorted sequence of actions 2 or a sorted total set of actions 10 shown in FIG. 9. As a presorting of the actions 2 has taken place, the result shown in FIG. 9 is, in spite of a different initial order or sequence, identical to the result shown in FIG. 6. Without a presorting, the result or the sorted sequence could also change.

FIGS. 10-12 show substeps of a variant of the method according to the invention, wherein the matrix 9 comprises example specific actions 2 relating to the operation of a molding machine, i.e. relating to a metering rate, a metering delay time, a metering volume, a decompression after metering, a cooling time, a back pressure and a switchover volume. For example, the specification “metering volume” can be taken to mean an “inputting of a metering volume” in the sense of an action. Analogously, the specification “cooling time” can be taken to mean an “inputting of a cooling time”.

FIG. 10 shows a set of example actions 2 already presorted, in particular alphabetically, with their mutual dependencies 1 marked by means of “X”.

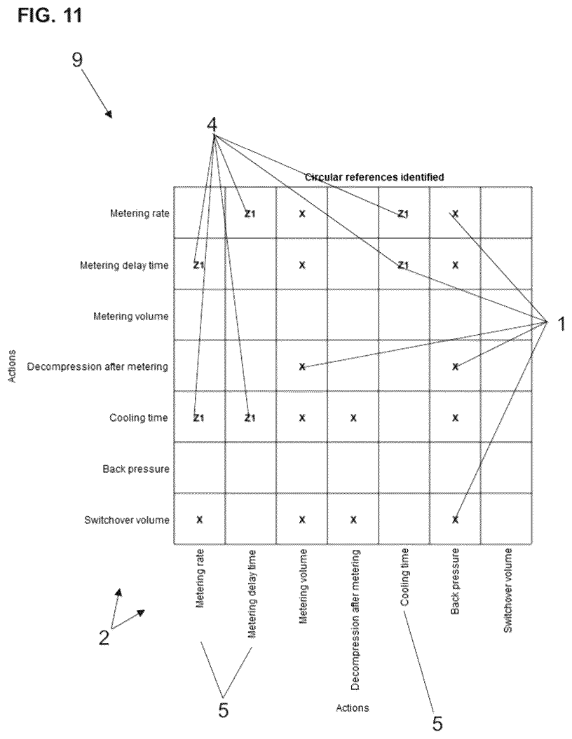

FIG. 11 shows the presorted actions 2 of FIG. 10 with identified, in particular and referenced, circular dependencies 4 between the circularly interdependent actions 5 or circular references.

In FIG. 11, the three actions 2 “cooling time”, “metering rate” and “metering delay time” are circularly interdependent actions 5 and are marked as circular reference Z1. In the case of a molding machine, in practice, the circular reference Z1 results from the circular dependencies 4 between “cooling time”, “metering rate” and/or “metering delay time” substantially as follows: in the case of a reduction of the cooling time, in the first step a resulting actual value of a metering time is compared with a cooling time. If the metering time is greater than the cooling time, in the second step it is checked, in particular by means of a computer program, whether a metering delay time is set to be greater than zero. If the metering delay time is equal to zero, a metering rate is set to be invalid. If the metering rate cannot be further increased on the machine side, the cooling time itself is again set to be invalid.

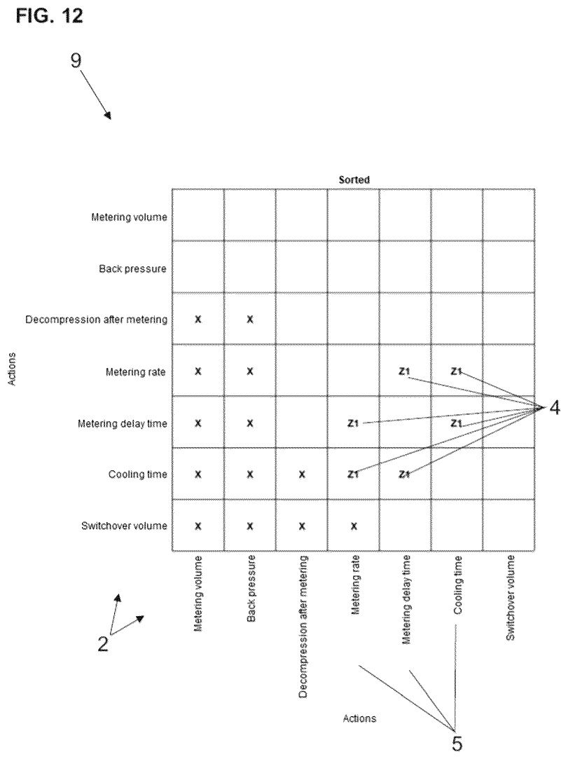

FIG. 12 shows the example matrix 9 of FIGS. 10 and 11 with identified, in particular and referenced, circular dependencies 4 and circularly interdependent actions 5 after sorting has been effected, i.e. in a sorted sequence of actions 2.

Specifically, the actions 2 of the sorted sequence of actions of FIG. 12 are set in turn in the course of a molding process, i.e. for example
in the first step, a metering volume and a back pressure are selected on the basis of a material and/or molded part; and
with reference to the metering volume and the back pressure, a corresponding decompression after a metering is set; and
in the third step, the three circularly interdependent actions 5 are considered simultaneously and set or executed in parallel and/or iteratively.

In the case of the third step or in the case of the execution of the circularly interdependent actions 5, the following is e.g. to be noted:
the resulting actual value of the metering time should not determine the cycle time, i.e. the metering time should be less than the cooling time;
the cooling time should be selected such that no warping and no deformation arises due to an ejector;
maximum machine limits with regard to the metering rate should be complied with; and/or
to avoid material damage, a corresponding metering delay should be provided.

Finally, as a fourth step, it can be provided that the switchover volume is set (i.e. generally as a switchover parameter of a speed-regulated phase into a pressure-regulated phase).

FIGS. 13-17 show, in particular graphic and/or tabular, screens 11,12, for example of a display unit of a molding machine, for assisting an operator during the operation of a molding machine, in particular in order to be able to perform a task 3 as efficiently as possible.

These screens 11,12 can, however, also be taken to mean a representation of the procedural logic according to which the system according to the invention, the control unit according to the invention and/or the molding machine according to the invention operates or operate.

FIGS. 13-16 show a first screen 11, which can output the actions 2 of the total set of actions 10 that are assigned to a particular task 3, in particular in tabular, list and/or graphic form, and/or provides them with status information, in particular relating to the state of completion of the individual actions 2.

FIG. 13 shows a sorted sequence of actions 2 for performing the task X, wherein none of the actions 2 has yet been completed. Carrying out the actions Q and T contained in the sorted sequence of actions results in the state of completion in FIG. 14.

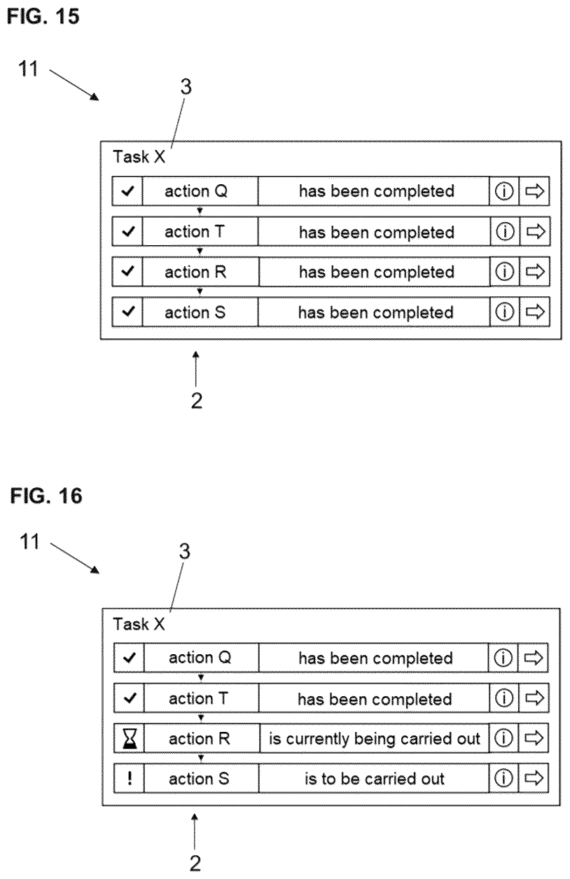

FIG. 14 shows the state of completion of the task 3 X with two executed or completed actions 2 Q and T and two open actions 2 R and S. To complete the task 3 X, the further actions 2 R and S are recommended, wherein carrying them out results in the state defined as ideal in FIG. 15.

FIG. 15 shows the state of the task X that is defined as ideal, wherein all necessary actions 2 have been successfully executed one after another in the sorted sequence.

After successful completion of a particular action 2, the operator can obtain a graphic and/or textual acknowledgement and/or is made aware of the next actions 2 still to be completed.

If at least one action 2 is carried out by the operator and/or the molding machine, the at least one effect on the remaining actions 2 is preferably determined qualitatively and/or quantitatively.

Effects, changes and/or deviations can be determined and/or evaluated as absolute and/or relative values and/or compared with stored threshold values, in particular in order to establish whether the latter have been exceeded and/or fallen below. The threshold values used here are often different, with the result that a classification, e.g. with regard to the significance, can be helpful.

In addition, individual and/or combined actual values resulting from determined effects, changes and/or deviations can be determined, evaluated, stored and/or checked.

If the effects, changes and/or deviations are evaluated as significant, in particular on the basis of a comparison and/or by means of a classification, an item of status information is changed and/or updated on the first screen 11 and/or second screen 12, in particular in order to make the operator aware of the change with the aid of a notification and/or in order to recommend a further course of action or updated sequence of sorted actions 2.

It may be the case that carrying out an action 2 causes the following actions 2 in the sorted sequence to become invalid.

FIG. 16 shows a state in which the actions 2 Q and T have already been completed and the action 2 R is currently being carried out, wherein, because of a change caused by the action 2 R, the action 2 S is now to be carried out subsequently.

FIG. 17 shows a second screen 12, which is preferably connected to the first screen 11, for example can be called up via an information button above the first screen 11 and provides the operator with further information on the contents of the first screen 11, e.g. by means of additional text on the usefulness and/or on the function of a particular action 2, and can assist the operator in this way.

By means of the second screen 12, the operator can be made aware, by means of textual and/or graphic assistance, of the parameters associated with a task 3 and/or action 2 and/or an advantageous sorted sequence of parameters and/or sorted sequence of the actions 2.

In the case of the example shown in FIG. 17, the in particular different parameters (“xy”) associated with the action 2 Q are listed, numbered (left-hand column) and provided with in each case associated values (right-hand column, “xx”), wherein the second screen 12 X reveals the following: to perform the action 2 Q, precisely two parameters are to be set, in particular in a particular order, wherein the parameter marked with the number “1” is to be set as the first. The parameter marked with the number “2” is to be set as the second. The parameters marked with “−” are already set correctly and need not be further considered. The setting of the parameters can be effected, for example, by means of a value, a drop-down menu, a check box or the like.

### LIST OF REFERENCE NUMBERS

1 dependencies
2 actions
3 task
4 circular dependencies
5 circularly interdependent actions
6 aggregate dependency
7 aggregate action
reduced set of actions
9 matrix
10 total set of actions
11 first screen
12 second screen

1. A method for operating a molding machine, the method comprising:
providing dependencies between, in particular unsorted and/or partially circularly interdependent, actions for performing at least one task, wherein the at least one task is or comprises an operation, a startup or shutdown, a maintenance and/or an optimization of a molding process and/or a molding machine and/or a mold; and
sorting the actions based on the dependencies between the actions.

2. The method according to claim 1, wherein a presorting of the actions is effected before the sorting of the actions.

3. The method according to claim 2, wherein the presorting of the actions is effected according to an, in particular strict, total order.

4. The method according to claim 1, wherein circular dependencies of the dependencies between the actions and/or the circularly interdependent actions are identified and/or referenced.

5. The method according to claim 4, wherein the circular dependencies between the circularly interdependent actions are combined into at least one aggregate dependency and/or the circularly interdependent actions connected by virtue of the circular dependencies are combined to form at least one aggregate action.

6. The method according to claim 5, wherein a reduced set of actions, which contains the actions minus the circularly interdependent actions contained in the at least one aggregate action as well as the at least one aggregate action, is sorted by means of, in particular topological, sorting.

7. The method according to claim 6, wherein the at least one aggregate action of the sorted reduced set of actions is replaced with the respective circularly interdependent actions, which circularly interdependent actions were combined beforehand to form the respective at least one aggregate action.

8. The method according to claim 5, wherein the circularly interdependent actions forming the respective at least one aggregate action are set simultaneously and/or iteratively, in particular by an operator.

9. The method according to claim 1, wherein those presorted and/or sorted actions which are independent of actions are additionally sorted at least once.

10. The method according to claim 1, wherein the dependencies between the actions are induced physically, logically, process-specifically, peripheral device-specifically, molding machine-specifically and/or tool-specifically.

11. The method according to claim 1, wherein the actions are;
a manual setting by an operator, and/or
a manual activity of an operator, and/or
an, in particular automatic, determination by a further computer program product, an assistance device or the like, and/or
an automatic performance by the molding machine.

12. The method according to claim 1, wherein the at least one task is or comprises:
a saving of energy, and/or
a reduction of a cycle time, and/or
an initial sampling, and/or
a setting-up, and/or
a heating-up, and/or
a starting-up, and/or
a stopping
of a molding process and/or a molding machine and/or a mold and/or a peripheral device.

13. The method according to claim 1, wherein:
the actions, and/or
the dependencies between the actions, and/or
the at least one task,
can be determined, changed and/or influenced, in particular by an operator.

14. The method according to claim 1, wherein the sorted actions are output, in particular in graphic, tabular and/or textual form.

15. The method according to claim 1, wherein actions for performing the at least one task that have already been:
Executed, and/or
are currently being processed, and/or
still to be performed, and/or
unavailable conceivable, and/or
deactivated
are obtained, acquired, output, in particular in graphic, tabular and/or textual form, and/or stored.

16. The method according to claim 1, wherein an operator is informed:
in particular as a reminder or warning, to set an action, and/or
that, in particular when a threshold value is exceeded and/or fallen below, an action or actions has or have effects on an action or actions and/or a process of operating the molding machine, and/or
what effect or effects, in particular exceeding and/or falling below a threshold value, the setting of an action or actions has or have on an action or actions and/or a process of operating the molding machine.

17. A computer program product, comprising commands which, when the program is executed by a computer, prompt it to perform the following steps for carrying out the method according to claim 1:
obtaining and/or acquiring dependencies between, in particular unsorted and/or partially circularly interdependent, actions for performing at least one task, wherein the at least one task is or comprises an operation, a startup or shutdown, a maintenance and/or an optimization of a molding process and/or a molding machine and/or a mold; and
sorting the actions based on the dependencies between the actions.

18. A system with a memory remote from a control unit of the molding machine, in which memory the computer program product according to claim 17 is stored, and wherein the system is preferably set up to execute the computer program using at least one processor.

19. A control unit for a molding machine, wherein the control unit is set up to communicate with the system according to claim 18.

20. A molding machine with a control unit according to claim 19.
